(19) United States
(12) Patent Application Publication
(10) Pub. No.: US 2018/0049446 A1
(43) Pub. Date: Feb. 22, 2018

(54) METHOD FOR AGING MEAT USING WHOLE GRAIN BARLEY AND AGED MEAT THEREOF

(71) Applicant: Chae Hwan LEE, Daegu (KR)

(72) Inventor: Chae Hwan LEE, Daegu (KR)

(21) Appl. No.: 15/239,274

(22) Filed: Aug. 17, 2016

(51) Int. Cl. A23B 4/10; A23L 13/70

(52) U.S. Cl. CPC A23B 4/10; A23V 2002/00; A23L 13/70

(57) ABSTRACT

The present invention relates to a method for aging meat using whole grain barley and aged meat using the same, and more particularly, to a method for aging meat using whole grain barley and aged meat using the same wherein a first layer of whole grain barley, a layer of meat, and a second layer of whole grain barley are filled sequentially into a vacuum packing material, thereby allowing the meat to be surrounded completely with the whole grain barley, then vacuum-packed, and finally aged in a low temperature aging refrigerator through wet aging.

### BACKGROUND OF THE INVENTION

### Field of the Invention

The present invention relates to a method for aging meat using whole grain barley and aged meat using the same, and more particularly, to a method for aging meat using whole grain barley and aged meat using the same wherein a first layer of whole grain barley, a layer of meat, and a second layer of whole grain barley are filled sequentially into a vacuum packing material, thereby allowing the meat to be surrounded completely with the whole grain barley, then vacuum-packed, and finally aged in a low temperature aging refrigerator through wet aging.

### Description of the Related Art

With the drastic increment of meat consumption, many studies on the improvement of the quality or taste of meat have been dynamically made. A method for adding food additives or natural food materials to meat is applied to improve the taste and flavor of meat, and otherwise, a method for aging meat is applied to provide excellent quality of meat and rich meat juice so that the quality and functionality of meat are improved.

A meat aging method using rice bran is disclosed in Korean Patent No. 10-0545531, wherein the meat aging method for meat such as beef, pork, chicken, duck, and lamp is carried out with rice bran containing rice germs, which remains, except rice hulls, in the production of white rice through the milling of paddy rice.

Further, a method for manufacturing a natural food additive, a food additive, and a meat aging method using the food additive are disclosed in Korean Patent Application Laid-open No. 10-2011-0043322, wherein after water and malt are mixed with malt syrup or oligo syrup made from rice, corn, sweet potato, or barley and then aged, the aged mixture is then mixed with sub material powder obtained by mixing ginseng powder, cornus fruit powder and Eucommia ulmoides oliver powder to the same ratio as each other, thereby manufacturing a food additive capable of improving the quality and properties of meat.

According to the conventional meat aging method using the rice bran, however, it is hard to completely remove the rice bran attached to the meat, and further, the meat may be easily burnt due to the rice bran attached thereto during the roasting process of the meat. Furthermore, if the rice bran is left at a normal temperature, the fat and lipase contained in the rice bran come into contact with each other to cause chemical reaction, so that they are synthesized to fatty acid and glycerol, thereby making the inherent properties and taste of the rice bran undesirably changed. That is, the rice bran is easily changed in taste at a normal temperature, and accordingly, if the meat aged using the rice bran is eaten, stomachache and diarrhea may be caused.

In case of the meat aging using the food additive made or using a variety of extracted liquids or fermented liquids, further, the aging process may be very complicated and not easy, and besides, the inherent taste and properties of the meat may be changed unpleasantly by means of the added food additive or extracted or fermented liquids.

### SUMMARY OF THE INVENTION

Accordingly, the present invention has been made in view of the above-mentioned problems occurring in the prior art, and it is an object of the present invention to provide a method for aging meat using whole grain barley wherein a first layer of whole grain barley, a layer of meat, and a second layer of whole grain barley are filled sequentially into a vacuum packing material, thereby allowing the meat to be surrounded completely with the whole grain barley, then vacuum-packed, and finally aged in a low temperature aging refrigerator through wet aging.

It is another object of the present invention to provide aged meat using a method for aging meat using whole grain barley wherein the whole grain barley is used in the aging process of meat in such a manner as allow the meat to be surrounded completely therewith in a vacuum packing material, and next, the meat is vacuum-packed and aged by means of wet aging.

To accomplish the above-mentioned objects, according to a first aspect of the present invention, there is provided a method for aging meat using whole grain barley, the method including: the preparation step of preparing a vacuum packing material, whole grain barley, and meat having a thickness in the range of 0.5 to 12 cm and applied uniformly with barley grass powder to the surface thereof; the meat and whole grain barley filling step of filling the interior of the vacuum packing material with a first layer of whole grain barley formed to a volume in the range of 20 to 200% with respect to the volume of meat, a layer of meat formed by arranging pieces of meat serially on the first layer of whole grain barley, and a second layer of whole grain barley formed on top of the layer of meat to a volume in the range of 20 to 200% with respect to the volume of meat; the vacuum packing step of conducting the vacuum packing for the meat and the whole grain barley filled in the vacuum packing material; and the wet aging step of conducting wet aging in which the vacuum-packed meat with the whole grain barley is aged for 7 to 40 days in a low temperature aging refrigerator kept at a temperature in the range of 0 to 4° C.

According to the present invention, preferably, the meat in the preparation step includes any one selected from the group consisting of beef, pork, chicken, and duck.

According to the present invention, preferably, the whole grain barley in the preparation step is germinated whole grain barley.

According to the present invention, preferably, in the meat and whole grain barley filling step, pieces of charcoal are additionally laid on the first layer of whole grain barley, and the pieces of charcoal contain 2 to 5 parts by weight with respect to 100 parts by weight of the whole grain barley.

To accomplish the above-mentioned objects, according to a second aspect of the present invention, there is provided meat aged according to the method as mentioned above.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a flow chart showing a method for aging meat using whole grain barley according to the present invention;

FIG. 2 is a diagram showing the photographs by step in the method for aging meat using whole grain barley according to the present invention;

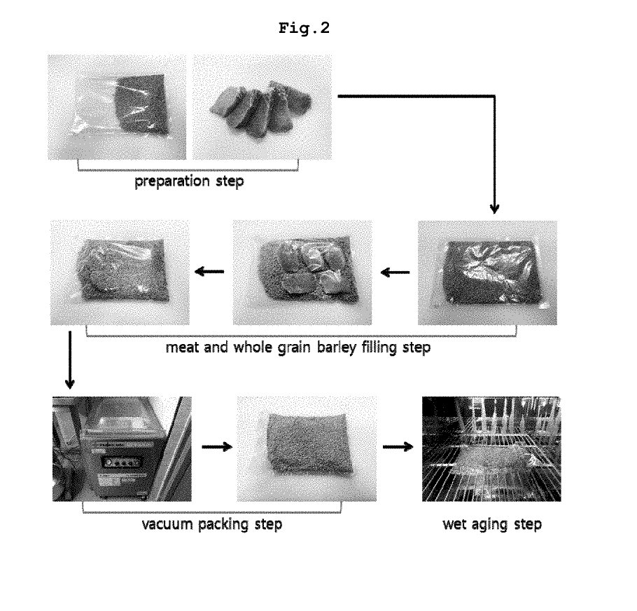

FIG. 3 is a graph showing the analysis results of calcium contents of aged meat;

FIG. 4 is a graph showing the essential amino acid contents of aged meat; and

FIG. 5 is a graph showing the non-essential amino acid contents of aged meat.

### DETAILED DESCRIPTION OF THE INVENTION

Hereinafter, an explanation on a method for aging meat using whole grain barley according to the present invention will be in detail given with reference to the attached drawing so that the present invention can be easily carried out by the skilled person in the art. The embodiment of the present invention is suggested so that the present invention is more fully explained to the person having mean knowledge in the art. The present invention may be modified in various ways and may have several exemplary embodiments. However, this does not limit the invention within the specific embodiment as will be discussed below.

In the description, when it is said that a portion “includes” a component, the portion may further include another component unless specific description in which another component is not included exists.

In the description, when it is said that a step is located on another step or before another step, it means that a step has a direct time series relation with another step and further has an indirect time series relation wherein the time series orders of the two steps are changed like the mixing step after the two steps.

In the description, terms, such as “about”, “substantially” and the like may be used when it is described that a given value approximates an inherent manufacturing and substance allowable error value, and they are used to prevent the disclosed content with the accurate or absolute value from being used by conscienceless invaders. In the description, terms, such as “steps of” and “-ing steps” do not mean “steps for”.

The present invention relates to a method for aging meat using whole grain barley and aged meat using the same, and the method includes the steps of: the preparation step of preparing a vacuum packing material, whole grain barley, and meat having a thickness in the range of 0.5 to 12 cm and applied uniformly with barley grass powder to the surface thereof; the meat and whole grain barley filling step of filling the interior of the vacuum packing material with a first layer of whole grain barley formed to a volume in the range of 20 to 200% with respect to the volume of meat, a layer of meat formed by arranging pieces of meat serially on the first layer of whole grain barley, and a second layer of whole grain barley formed on top of the layer of meat to a volume in the range of 20 to 200% with respect to the volume of meat; the vacuum packing step of conducting the vacuum packing for the meat and the whole grain barley filled in the vacuum packing material; and the wet aging step of conducting wet aging in which the vacuum-packed meat with the whole grain barley is aged for 7 to 40 days in a low temperature aging refrigerator kept at a temperature in the range of 0 to 4° C.

Now, the method for aging meat using whole grain barley (hereinafter, referred to as “meat aging method”) according to the present invention will be in detail explained. The meat aging method according to the present invention will be more clearly understood by manufacturing processes as will be discussed below.

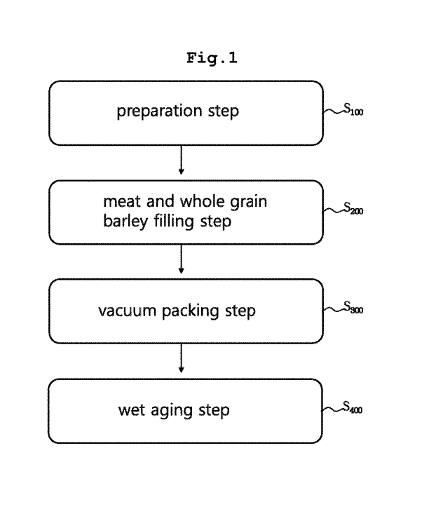

FIG. 1 is a flow chart showing a method for aging meat using whole grain barley according to the present invention.

First, a preparation step is carried out (Step S₁₀₀).

In the preparation step, a vacuum packing material, whole grain barley, and meat having a thickness in the range of 0.5 to 12 cm and applied uniformly with barley grass powder on the surface thereof are prepared.

The meat aging method according to the present invention is characterized in that the meat is aged with whole grain barley. The whole grain barley is abundant in dietary fibers, vitamins and inorganic elements, thereby supplying nutrients insufficient from the dietary life focused on rice. The whole grain barley contains larger amounts of components such as vitamin B1, vitamin B2, niacin, folic acid, calcium, iron and so on than rice, thereby having excellent effects of preventing diseases like beriberi, pellagra, anemia and so on, also contains a large amount of dietary fibers to accelerate the peristaltic movement and digestion of the intestines, thereby removing constipation, and further helps the cultivation of beneficial bacteria to stimulate the synthesis of vitamin B6 and pantothenic acid for skin nutrition. Moreover, the whole grain barley absorbs carcinogenic substances such as fatty acids, cholesterol, heavy metals, and nitrosoamine eaten through foods thereto and discharges the absorbed carcinogenic substances to the outside of the human body, thereby suppressing the generation of colon cancer. Especially, beta-glucans contained in the whole grain barley are decomposed into small molecule fatty acids to suppress the synthesis of cholesterol in the liver, and drastic changes of urine glucose are small through the intake of the whole grain barley, thereby preventing the generation of obesity. The whole grain barley contains the above-mentioned functional substances in large amounts, thereby having excellent efficiencies and effects as food. Besides, the whole grain barley has a moisturizing effect and a good humidity control function, so that it can be used as a natural humidity control agent.

Accordingly, the meat is aged with the whole grain barley having excellent efficiencies and effects as food, so that the lean flavor and savory taste of the whole grain barley are permeated into the meat, thereby removing the unpleasant smell of the meat to enhance the flavor and taste of the meat. Also, the oil of the meat is maintained to an optimal state, and thus, the meat has an excellent savory taste. Further, the delicate smell of the barley is added to the meat, thereby providing a good appetite. Additionally, if the meat is aged with the whole grain barley, the loss of meat juice is prevented to a maximum degree by means of the whole grain barley attached to the surface of the meat, and further, the water of the whole grain barley is absorbed to the meat, thereby making the juice of the meat become rich. That is, the hulls of the whole grain barley are aged together with the meat to allow the water of the meat to be controlled to an optimal state, so that the quality of the protein portion of the meat becomes softened and the quality of the fat portion of the meat becomes harder, thereby allowing the taste and food texture of the meat to be excellent.

According to the present invention, the meat in the preparation step includes any one selected from the group consisting of beef, pork, chicken, and duck.

According to the present invention, further, the meat has a thickness in the range of 0.5 to 12 cm.

If the thickness of the meat is less than 0.5 cm, the thickness of the meat is too low, and thus, when the meat is aged in the wet aging process, a large amount of meat juice is lost to make the quality of meat become hard, so that the taste and food texture of the meat are all deteriorated. To the contrary, if the thickness of the meat is over 12 cm, the thickness of the meat is too high, and thus, the smell and effective ingredients of the whole grain barley are not permeated sufficiently into the meat, so that the lean flavor and savory taste of the whole grain barley are not transferred to the aged meat. Further, the aging time is extended to cause the inherent taste of the meat to disappear, thereby degrading the quality of the meat, and the changes in the quality of meat are not observed by the naked eyes. Therefore, most desirably, the meat has a thickness in the range of 0.5 to 12 cm.

According to the present invention, moreover, the whole grain barley in the preparation step is germinated whole grain barley.

In oriental medicine, malt, which is germinated barley, is one of representative medical materials helping a digestion function. The germinated barley makes intestines discharge many digestive enzymes, thereby helping digestion, and if digestion is good, blood circulation is gently carried out, blood is good, chronic fatigue disappears, and immunity is increased. In the germination process of the barley, antioxidants like coumaric acid are increased to more than four times. If the meat is aged with the germinated whole grain barley, accordingly, the water of the meat is controlled to an optimal state, and the lean flavor and savory taste of the whole grain barley are permeated into the meat, thereby more increasing the effects of the meat aging method using the whole grain barley. Further, the digestion is good when the meat is eaten, and the effective ingredients, taste, and flavor of the whole grain barley are much more contained in the meat, thereby more increasing the taste and flavor of the aged meat.

According to the present invention, the meat in the preparation step is applied uniformly with barley grass powder on the surface thereof.

The meat applied with fine barley grass powder on the surface thereof and then aged with the whole grain barley has much more lean flavor and savory taste than the meat aged just with the whole grain barley, so that when the barley grass powder is applied to the meat, strong preference from consumers is obtained. Further, the effective ingredients of the barley can be contained much more in the meat, thereby increasing the functionality of the barley.

Next, a meat and whole grain barley filling step is carried out (Step S₂₀₀).

First, a first layer of whole grain barley is formed in the interior of the vacuum packing material prepared in the preparation step to a volume in the range of 20 to 200% with respect to the volume of meat, a layer of meat is formed in such a manner as to arrange pieces of meat serially on the first layer of whole grain barley, and a second layer of whole grain barley is formed on top of the layer of the meat to a volume in the range of 20 to 200% with respect to the volume of meat, thereby filling the interior of the vacuum packing material.

Clean, well dried and non-chemical whole grain barley is flattedly filled in the vacuum packing material to the volume in the range of 20 to 200% with respect to the volume of meat, and after that, the pieces of meat are arranged serially on the first layer of whole grain barley, without being contacted with each other. Next, the second layer of whole grain barley is coveredly formed on top of the layer of meat to the volume in the range of 20 to 200% with respect to the volume of meat. That is, the first layer of whole grain barley, the layer of meat, and the second layer of whole grain barley are filled sequentially in the vacuum packing material in such a manner as to allow the whole grain barley to completely surround the meat therewith.

After the whole grain barley is filled in the vacuum packing material at a time, if the meat is pushed into the vacuum packing material, the pieces of meat may come into contact with each other, so that they are not aged uniformly in the aging process, thereby having a bad aging efficiency. Further, it is hard to allow the whole grain barley filled in the vacuum packing material to completely surround the meat, thereby reducing the effect of increasing the meat juice.

According to the present invention, pieces of charcoal are additionally laid on the first layer of whole grain barley in the meat and whole grain barley filling step.

Charcoal is a porous material on which microorganisms grow. Especially, charcoal is adequate to the environment for the survival of the actinomycetes having excellent decomposition of organic matters, so that charcoal absorbs the contaminated components in the air or harmful impurities thereto and decomposes them, thereby purifying the air and removing the bad odor. Further, charcoal has excellent growth accelerating action, water molecule activation, and aging effect, and thus, if food is stored in a pottery in which charcoal is put, the generation of the smell from the food or the generation of the harmful gas from the food stored is suppressed or reduced, thereby allowing the food to be freshly stored. So as to suppress or reduce the generation of the harmful gas from the food during the food is stored, according to the present invention, the pieces of charcoal are used, and thus, the meat is freshly kept in the aging process thereof and the aging of the meat is accelerated. When the pieces of charcoal are added to the first layer of whole grain barley in the meat and whole grain barley filling step, it is important to prevent the pieces of charcoal from coming into contact with the surface of meat. However, if the pieces of charcoal come into direct contact with the surface of meat, the surface of the aged meat is stained with the charcoal, and accordingly, the stained portion of the meat should be removed upon the intake of the meat, thereby increasing a quantity of meat lost. The portion of meat contacted with the charcoal is more rapidly aged in the aging process, thereby undesirably making the whole portion of meat ununiformly aged.

According to the present invention, the pieces of charcoal are additionally laid on the first layer of whole grain barley in the meat and whole grain barley filling step, and in this case, the pieces of charcoal contain 2 to 5 parts by weight with respect to 100 parts by weight of the whole grain barley.

If the pieces of charcoal contain less than 2 parts by weight with respect to 100 parts by weight of the whole grain barley, the number of pieces of charcoal added is too small, so that there is no meaning at all in the addition of the charcoal. Contrarily, if the pieces of charcoal contain more than 5 parts by weight with respect to 100 parts by weight of the whole grain barley, the number of pieces of charcoal added is too large, thereby lowering economical efficiencies, and further, the meat is aged in the state of being very close to the charcoal, thereby undesirably causing a given portion of the meat to be early aged, without having the entire portion of the meat aged uniformly.

Accordingly, the first layer of whole grain barley is formed in the interior of the vacuum packing material prepared in the preparation step to the volume in the range of 20 to 200% with respect to the volume of meat, and after that, the pieces of charcoal containing 2 to 5 parts by weight with respect to 100 parts by weight of the whole grain barley are added to the first layer of whole grain barley in such a manner as to avoid the contact with the layer of meat. Next, the layer of meat is formed in such a manner as to arrange the pieces of meat serially on the first layer of whole grain barley, and the second layer of whole grain barley is formed on top of the layer of meat to the volume in the range of 20 to 200% with respect to the volume of meat. Accordingly, the first layer of whole grain barley, the layer of meat, and the second layer of whole grain barley are filled sequentially in the vacuum packing material in such a manner as to allow the whole grain barley to completely surround the meat therewith.

Next, a vacuum packing step is carried out (Step S₃₀₀).

The vacuum packing step for the meat and the whole grain barley filled in the vacuum packing material in the meat and whole grain barley filling step is carried out.

So as to allow the meat to be aged through wet aging, the interior of the vacuum packing material is filled sequentially with the first layer of whole grain barley, the layer of meat, and the second layer of whole grain barley in such a manner as to allow the whole grain barley to completely surround the meat therewith. Next, air is removed from the vacuum packing material, and the vacuum packing material is compressed.

After that, a wet aging step is carried out (Step S₄₀₀).

The meat packed through the vacuum packing step is aged for 7 to 40 days in a low temperature aging refrigerator kept at a temperature in the range of 0 to 4° C.

Meat aging methods are classified into dry aging and wet aging. Characteristics of the dry aging and wet aging are listed in Table 1.

TABLE 1

| Dry aging | Wet aging |
|---|---|
| Meat is aged in an aging | Meat is aged in a vacuum |
| refrigerator, while being | packing material |
| exposed naturally in the air | Aging speed is proportional |
| Temperature in the range of | to temperature |
| 1 to 3° C. is kept | The loss of meat is |
| Moisture in the range of 70 | minimized |
| to 85% is kept | Tenderness and flavor of |
| Hard and dried surface is | meat are improved through |
| cut and inner portion is used | appropriate aging |
| If aging is extended | |
| further, the water of meat is | |
| reduced | |
| Taste and food texture are | |
| good through concentration | |

According to the present invention, the meat is aged through wet aging. Wet aging is conducted in such a manner where meat is aged in a vacuum packing material. The meat aged through the wet aging is not exposed to the air, unlike the meat aged through dry aging, thereby preventing water contained therein from being evaporated, and accordingly, there is no need to cut out the hard and dried surface of the meat, thereby minimizing the loss of meat. Further, the tenderness of meat is improved through appropriate aging, thereby providing rich meat juice and taste.

According to the present invention, the meat is aged through the wet aging, and at the same time, the whole grain barley is aged together with the meat, thereby improving the advantages of the wet aging. According to the present invention, that is, the loss of the juice contained in the meat aged using the whole grain barley can be prevented to the maximum by means of the whole grain barley attached to the surface of the meat, and on the contrary, the water contained in the whole grain barley is absorbed to the meat to allow the juice and taste of the meat to become rich. Accordingly, the hulls of the whole grain barley are aged together with the meat to allow the water of the meat to be controlled to the optimal state, so that the quality of the protein portion of the meat becomes softened and the quality of the fat portion of the meat becomes harder, thereby allowing the taste and food texture of the meat to be excellent.

According to the present invention, the low temperature aging refrigerator in the wet aging step is kept at a temperature in the range of 0 to 4° C.

If a temperature of the low temperature aging refrigerator is less than 0° C., the temperature is too low to make the meat aged well, and the aging time may be extended further, thereby decreasing the food texture of the meat. On the contrary, if a temperature of the low temperature aging refrigerator is over 4° C., the temperature is too high to keep the inherent taste of the meat during the aging, thereby undesirably causing the change in quality and denaturation of the meat.

According to the present invention, further, the meat vacuum-packed together with the whole grain barley is aged for 7 to 40 days in the low temperature aging refrigerator in the wet aging step.

If the aging time of the meat is less than 7 days in the wet aging step, the meat is not aged sufficiently to cause the quality of meat to be lowered, and on the contrary, if the aging time of the meat is over 40 days, the meat is aged for long hours to cause the inherent taste of the meat to be lost during the aging, thereby undesirably causing the change in quality and denaturation of the meat.

Accordingly, most desirably, in the wet age step the meat is aged for 7 to 40 days in the low temperature aging refrigerator kept at a temperature in the range of 0 to 4° C.

In the wet aging step, the aging of the meat is conducted, while being not limited in the low temperature aging refrigerator. That is, the aging of the meat may be conducted in all places or environments wherein a temperature in the range of 0 to 4° C. is kept.

In a meat roasting step through which the meat aged through the meat aging method according to the present invention is eaten, the packing material is first removed, and then, a first roasting step for roasting the meat to which the whole grain barley is attached is conducted. Next, a second roasting step is conducted wherein the whole grain barley attached to the surface of the meat is removed and the meat is roasted.

The reason why the roasting step is divided into the first roasting step and the second roasting step is that the discharge and loss of the meat juice are prevented to the maximum by instantly roasting the meat with strong fire in the state wherein the whole grain barley is attached to the surface of the meat and further that the lean flavor and savory taste of the whole grain barley are contained in the meat, thereby removing the unpleasant smell of the meat to enhance the flavor and taste of the meat.

Accordingly, most desirably, the meat roasting step, through which the meat aged through the meat aging method according to the present invention is eaten, is divided into the first roasting step wherein the packing material is first removed from the meat and the meat to which the whole grain barley is attached is roasted and the second roasting step wherein the whole grain barley attached to the surface of the meat is removed and the meat is roasted.

### Embodiment

According to the present invention, the meat with the whole grain barley attached thereto was aged.

### 1. Preparation Step

A vacuum packing material, cleaned and well-dried germinated whole grain barley, pieces of charcoal, and pieces of pork loin cut to a thickness of 2 cm were prepared.

### 2. Meat and Whole Grain Barley Filling Step

A first layer of whole grain barley was formed in the interior of the vacuum packing material to a volume of about 100% with respect to the volume of meat, and the pieces of charcoal were added to the interior of the first layer of whole grain barley in such a manner as to avoid the contact with the layer of meat. Next, a layer of meat was formed by serially arranging the pieces of pork loin on the first layer of whole grain barley in such a manner as to allow the pieces of pork loin to be not contacted with each other, and a second layer of whole grain barley was coveredly formed on top of the layer of meat to the volume of about 100% with respect to the volume of meat. That is, the interior of the vacuum packing material was filled sequentially with the first layer of whole grain barley, the layer of meat, and the second layer of whole grain barley in such a manner as to allow the whole grain barley to completely surround the meat therewith.

### 3. Vacuum Packing Step

After the interior of the vacuum packing material had been filled sequentially with the first layer of whole grain barley, the layer of meat, and the second layer of whole grain barley in such a manner as to allow the whole grain barley to completely surround the meat therewith, air was removed from the vacuum packing material, and the vacuum packing material was compressed.

### 4. Wet Aging Step

The pork packed with the whole grain barley through the vacuum packing step was aged through wet aging for 14 days in a low temperature aging refrigerator kept at a temperature in the range of 0 to 4° C.

### Comparison Example 1

Meat was aged through the meat aging method according to the present invention, but instead of the whole grain barley, rice bran was used.

### Comparison Example 2

Meat was aged through a general wet aging method, without using whole grain barley or rice bran.

### [Sensory Test]

The sensory tests for the embodiment of the present invention and the comparison examples were carried out.

The sensory tests were carried out for the meat of the embodiment of the present invention which was aged with the whole grain barley attached thereto through wet aging, for the meat of the Comparison Example 1 which was aged through the meat aging method according to the present invention, while using rice bran, instead of the whole grain barley, and for the meat of the Comparison Example 2 which was aged through a general wet aging method.

The sensory tests were carried out by randomly selecting 100 men and women adult panels aged 20 to 60 years to allow the aged meat according to the present invention, the Comparison Example 1 and the Comparison Example 2 to be eaten by them and by evaluating their preference such as taste, smell, food texture, and flavor through a ten point evaluation method. In this case, the aged meat according to the present invention, the Comparison Example 1 and the Comparison Example 2 were first roasted with strong fire in the state where the whole grain barley or the rice bran was attached to the surface of the pork loin and secondarily roasted after removing the whole grain barley or the rice bran. Next, the roasted meat (pork loin) was eaten by the 100 panels, and the results were listed in Table 2.

TABLE 2

| | | | Food | | Total |
|---|---|---|---|---|---|
| | Taste | Smell | texture | Flavor | Preference |
| Embodiment | 9.5 | 9.3 | 9.8 | 9.9 | 9.6 |
| Comparison | 5.8 | 3.0 | 4.8 | 3.9 | 4.4 |
| Example 1 | | | | | |
| Comparison | 4.3 | 2.9 | 2.7 | 2.5 | 3.1 |
| Example 1 | | | | | |

* Sensory test value (10: very good, 0: very bad)

Table 2 shows the mean values in the sensory test values obtained by the 100 men and women adult panels aged 20 to 60 years, and the meat according to the embodiment of the present invention had stronger total preference than the meat according to the Comparison Example 1 and the Comparison Example 2.

Accordingly, it could be appreciated that if the meat was aged with the whole grain barley, the lean flavor and savory taste of the whole grain barley were permeated into the meat, thereby removing the unpleasant smell of the meat to enhance the flavor and taste of the meat, and further, the aging was sufficiently carried out so that the change in the quality of meat was observed by the naked eyes. Through the change of amino acids, the change in quality on the protein portion of the meat was checked by the naked eyes, and the food texture of the meat was good, thereby advantageously improving the quality of meat. Moreover, the surface of the meat became hard during the meat aging process, while the loss of meat juice was being prevented to the maximum, and the water of the whole grain barley was absorbed to the meat to allow the meat juice to be more abundant, so that the quality of the protein portion of the meat became softened and the quality of the fat portion of the meat became harder, thereby allowing the food texture of the meat to be excellent.

Moreover, the interior of the vacuum packing material was filled sequentially with the first layer of whole grain barley, the layer of meat, and the second layer of whole grain barley in such a manner as to allow the whole grain barley to completely surround the meat therewith, and then, the meat packed together with the whole grain barley was aged through the wet aging in the low temperature aging refrigerator. Accordingly, the meat s distributed in the state of being packed, thereby minimizing the loss of water in the distribution process, and the smell of the whole grain barley was contained in the meat, thereby increasing the taste and flavor of the meat. It was therefore checked that the meat aged according to the embodiment of the present invention had stronger preference such as taste, smell, food texture and flavor than the meat aged according to the Comparison Example 1 wherein the rice bran was used and the Comparison Example 2 wherein the general wet aging method was adopted.

As appreciated from Table 2, in case of the meat aged with the rice bran according to the Comparison Example 1, it was hard to completely remove the rice bran attached to the meat, and further, the meat was easily burnt due to the rice bran attached thereto during the first and second roasting processes, so that the smell of burning and the foreign body sensation caused by the rice bran could be felted when the meat was eaten, thereby having low evaluation values in the preference such as taste, smell, food texture and flavor to cause the acceptance and preference of consumers to be lowered.

On the other hand, in case of the meat aged through the general wet aging method according to the Comparison Example 2, an amount of meat juice was substantially smaller than those in the meat according to the present invention and the Comparison Example 1, so that it was checked that when the meat was roasted, it became hard, and when the meat was eaten, persons who ate the meat felt like the quality of meat was hard and the water of meat was insufficient, thereby having very weak preference on the food texture of the meat. Furthermore, the meat according to the Comparison Example 2 was not aged better than the meat according to the embodiment of the present invention wherein the meat was aged using the whole grain barley and the meat according to the Comparison Example 1 wherein the meat was aged using the rice bran, thereby having very weak preference on the taste and flavor of the meat.

In conclusion, it was checked that the meat was aged with the whole grain barley according to the embodiment of the present invention could prevent the losses of meat juice and meat to the maximum by means of the whole grain barley attached to the surface of the meat, and on the contrary, the water of the whole grain barley was absorbed to the water to allow the meat juice to become rich. Further, it was checked that the lean flavor and savory taste of the whole grain barley were permeated into the meat, thereby removing the unpleasant smell of the meat to enhance the preference of the consumers on the flavor and taste of the meat.

### [Ingredient Analysis Test]

Ingredient analysis tests were carried out for meat (hereinafter, referred to as “vacuum-packed meat”) aged through general wet aging and meat (hereinafter, referred to as “vacuum-packed meat with whole grain barley”) aged through wet aging together with the whole grain barley.

### 1. Samples

Samples were prepared with 300 g of pork loin (hereinafter, referred to as “pork loin before vacuum packing’ or “material meat before packing”) sliced to a thickness of 2 cm, 900 g of pork loin (hereinafter, referred to as “vacuum-packed meat”) packed in a vacuum packing material and kept and aged for 14 days at a place in which a temperature in the range of 0 to 4° C. is kept, 900 g of pork loin (hereinafter, referred to as “vacuum-packed meat with whole grain barley”) packed together with 500 g of whole grain barley in a vacuum packing material and kept and aged for 14 days at a place in which a temperature in the range of 0 to 4° C. is kept, 500 g of whole grain barley (hereinafter, referred to as “whole grain barley before vacuum packing”) used for the vacuum packing, and 500 g of whole grain barley (hereinafter, referred to as “whole grain barley in vacuum-packed meat”) removed upon the test after the vacuum-packed meat with whole grain barley had been aged. The items of the tests for the samples are listed in Table 3 below.

### 2. Test Items

All tests for measuring water, water activity, general ingredients, physical properties, inorganic matters, vitamins, fatty acids and amino acids were repeatedly carried out three times according to the method recorded on “food codes” published by Korean ministry of food and drug safety by a micro biological resource research institute at Keimyung university as an authorized inspection agency by Korean ministry of food and drug safety, and the tested mean values were indicated in Table 3. The indication was conducted with the test reports on which values are inputted according to the description on the food codes.

TABLE 3

| | Amounts | |
|---|---|---|
| Sample Names | used | Test item |
| Pork loin | 300 g | water |
| Vacuum-packed meat | 900 g | water, water activity, |
| | | general ingredients (crude |
| | | proteins, crude fats and |
| | | crude ashes), physical |
| | | properties (pH, hardness, |
| | | attachment, chewiness, |
| | | springiness, and |
| | | cohesiveness), inorganic |
| | | matters (calcium, iron, and |
| | | selenium), vitamins (vitamins |
| | | B1, B2 and E, folic acid, and |
| | | niacin), fatty acids (37 |
| | | kinds), cholesterol, acid |
| | | values, peroxide values, and |
| | | amino acids (17 kinds and |
| | | GABA) |
| Vacuum-packed meat | 900 g | water, water activity, |
| with whole grain | | general ingredients (crude |
| barley | | proteins, crude fats and |
| | | crude ashes), physical |
| | | properties (pH, hardness, |
| | | attachment, chewiness, |
| | | springiness, and |
| | | cohesiveness), inorganic |
| | | matters (calcium, iron, and |
| | | selenium), vitamins (vitamins |
| | | B1, B2 and E, folic acid, and |
| | | niacin), fatty acids (37 |
| | | kinds), cholesterol, acid |
| | | values, peroxide values, and |
| | | amino acids (17 kinds and |
| | | GABA) |
| Whole grain barley | 500 g | water, water activity, |
| before vacuum | | general ingredients (crude |
| packing | | proteins, crude fats and |
| | | crude ashes), inorganic |
| | | matters (calcium, iron, and |
| | | selenium), vitamins (vitamins |
| | | B1, B2 and E, folic acid, and |
| | | niacin), fatty acids (37 |
| | | kinds), cholesterol, acid |
| | | values, peroxide values, and |
| | | amino acids (17 kinds and |
| | | GABA) |
| Whole grain barley | 500 g | water, water activity, |
| in vacuum-packed | | general ingredients (crude |
| meat | | proteins, crude fats and |
| | | crude ashes), inorganic |
| | | matters (calcium, iron, and |
| | | selenium), vitamins (vitamins |
| | | B1, B2 and E, folic acid, and |
| | | niacin), fatty acids (37 |
| | | kinds), cholesterol, acid |
| | | values, peroxide values, and |
| | | amino acids (17 kinds and |
| | | GABA) |

### 3. Change in Water Content

Main factors of meat aging include aging time, aging temperature, relative humidity, air flow and so on. Such factors are important because they had relations with flavor, the limit time of distribution, product shrinkage, contamination caused by microorganisms, other qualities, and economical efficiency. Particularly, water content is a main factor capable of determining the aging of meat, and accordingly, the water content for the respective meat was measured in the ingredient analysis tests. The measured results are listed in Table 4.

TABLE 4

| | | | Vacuum- | | |
|---|---|---|---|---|---|
| | | | packed meat | Whole | |
| | | Vacuum- | with whole | grain | |
| | Pork loin | packed | grain | barley | Whole grain |
| | before | meat | barley | before | barley in |
| | vacuum | (aging for | (aging for | vacuum | vacuum- |
| Item | packing | 14 days) | 14 days) | packing | packed meat |
| Water | 67.7 | 70.1 | 54.6 | 17.7 | 31.6 |
| content | | | | | |
| (g/100 g) | | | | | |
| Water | — | +2.4 | −13.1 | — | +13.9 |
| increment | | | | | |
| and | | | | | |
| decrement | | | | | |
| (Δvalue) | | | | | |
| Water | — | 0.974 | 0.967 | 0.82 | 0.960 |
| activity | | | | | |
| Processing | — | 0.926 | 1.406 | — | 0.831 |
| factor | | | | | |

Processing factor = (100-water content after aging)/(100-water content before aging)

The water content of the vacuum-packed meat was 70.1 g/100 g, which was more increased by 2.4 g/100 g than 67.7 g/100 g of water content of the pork loin before vacuum packing, and the water content of the vacuum-packed meat with whole grain barley was 54.6 g/100 g, which was more decreased by 13.1 g/100 g than 67.7 g/100 g of water content of the pork loin before vacuum packing. This meant that the juice of the vacuum-packed meat was discharged as time had been passed so that the water content of the vacuum-packed meat was increased, and in case of the vacuum-packed meat with whole grain barley, to the contrary, the juice discharged from the vacuum-packed meat was transferred to the vacuum-packed whole grain barley. The water content of the whole grain barley before vacuum packing was 17.7 g/100 g, but the water content of the whole grain barley in the vacuum-packed meat was 31.6 g/100 g, which was more increased by 31.6 g/100 g than that in the whole grain barley before vacuum packing, so that the increment and decrement value of the vacuum-packed meat with whole grain barley was similar to that of the whole grain barley in the vacuum-packed meat. It was appreciated from the above values that the juice and water of the vacuum-packed meat were transferred to the whole grain barley packed together with the meat. Further, the water activity of the vacuum-packed meat with whole grain barley was 0.967, and the water activity of the whole grain barley in the vacuum-packed meat was 0.960, so that it was appreciated from the similar results that the balance of water was achieved. Furthermore, the water activity of the vacuum-packed meat was 0.974, which meant that the juice of the meat was discharged and thus remained in the vacuum packing material.

Processing factors were calculated with the change in the water contents. It was accordingly checked that a processing factor of the vacuum-packed meat was 0.926, which meant that water was increased, a processing factor of the vacuum-packed meat with whole grain barley was 1.406, which meant that water was decreased, and a processing factor of the whole grain barley in the vacuum-packed meat was 0.831, which meant that water was increased.

In case of the vacuum-packed meat with whole grain barley, therefore, the most important water control in the storage conditions of meat was achieved to ensure the improvement of storage, and while the juice and water of the meat were being transferred to the whole grain barley, their nutrients were mutually changed with each other through their attached surfaces. The increment in the water content of the vacuum-packed meat was caused by the juice discharged from the meat during the aging of the meat, which was checked by the naked eyes. As recognized from the sensory tests, the taste, smell, food texture and flavor of the vacuum-packed meat become remarkably bad. That is, the aging of the meat with the whole grain barley removed the disadvantages caused by the aging of the meat through the general vacuum packing, and the juice of the meat could be protected through the water control of the whole grain barley to improve the quality and food texture of the meat, thereby enhancing the merchantability of the meat.

### 4. General Ingredients

So as to check changes in general ingredients and transfer of nutrients in accordance with the aging conditions of meat, the ingredient analysis tests for comparing crude proteins, crude fats and crude ashes were carried out, and the analysis results are listed in Table 5.

TABLE 5

| | | Vacuum- | | |
|---|---|---|---|---|
| | | packed meat | | |
| | | with whole | Whole grain | |
| | Vacuum- | grain | barley | Whole grain |
| | packed meat | barley | before | barley in |
| | (aging for | (aging for | vacuum | vacuum- |
| Item | 14 days) | 14 days) | packing | packed meat |
| Crude | 22 | 35 | 9 | 8 |
| proteins | | | | |
| Crude fats | 6.1 | 8.8 | 2.2 | 1.1 |
| Crude ashes | 1.1 | 1.5 | 1.8 | 1.6 |

(Unit: g/100 g)

The crude proteins, crude fats and crude ashes of the vacuum-packed meat with whole grain barley were increased, and those of the vacuum-packed meat were decreased. This meant that the changes in the general ingredients and the transfer of the nutrients were generated by the changes in the water contents. Further, the increment of the crude proteins had a relation with the increment of amino acids, and the increment of the crude fats had a relation with the change in fatty acids. The change in the crude ashes meant that the changes in inorganic matters among micronutrients occurred at the same time.

### 5. Physical Properties

So as to check the changes in physical properties in accordance with the aging conditions of meat, color, hardness, attachment, chewiness, springiness, and cohesiveness were checked, and the checked results are listed in Table 6.

TABLE 6

| | | Vacuum-packed | |
|---|---|---|---|
| | | whole grain | |
| | Vacuum-packed | barley and | Difference |
| | meat | meat | value (Δvalue) |
| | (aging for 14 | (aging for 14 | between two |
| Item | days) | days) | aging methods |
| Redness (a*) | 8.47 | 9.05 | 0.58 |
| Yellowness | 1.86 | 6.71 | 4.85 |
| (b*) | | | |
| Lightness (L*) | 29.71 | 16.2 | −13.51 |
| Hardness | 916.748 | 2901.426 | 1984.678 |
| Attachment | −188.066 | −25.126 | 162.94 |
| Chewiness | 399.917 | 1308.423 | 908.506 |
| Springiness | 0.967 | 0.79 | −0.177 |
| Cohesiveness | 0.451 | 0.61 | 0.159 |

The redness and yellowness of color of the vacuum-packed meat with whole grain barley were higher than those of the vacuum-packed meat, and the vacuum-packed meat with whole grain barley had a more vivid red color than other samples, so that the preference in the control of the appetite became strong. To the contrary, lightness had a relation with water so that the lightness of the vacuum-packed meat with whole grain barley was lower than that of the vacuum-packed meat.

Further, the hardness of the vacuum-packed meat with whole grain barley was 2901.426, and that of the vacuum-packed meat was 916.748. It was appreciated that the hardness of the vacuum-packed meat with whole grain barley was higher 3.2 times than that of the vacuum-packed meat. Of course, the chewiness, cohesiveness, and attachment of the vacuum-packed meat with whole grain barley were higher than those of the vacuum-packed meat. This meant that the physical properties of the vacuum-packed meat with whole grain barley were hard, without being softened. On the other hand, the springiness of the vacuum-packed meat having high water content was higher 0.17 times than that of the vacuum-packed meat with whole grain barley.

As meat was aged, the physical properties of meat were changed. Particularly, the changes in the hardness and chewiness determining the food texture of the meat were obviously made. In case of the vacuum-packed meat, the tenderness was improved during the aging, but the water contained in the meat was discharged, thereby causing the texture of the meat to become remarkably bad. According to the present invention, therefore, as the meat was aged with the whole grain barley through the wet aging, the quality of meat became hard through the cooperative action between the whole grain barley and the meat to provide good food texture, without being soften in the physical properties thereof, thereby removing the disadvantages of the general wet aging method.

### 6. Micronutrients

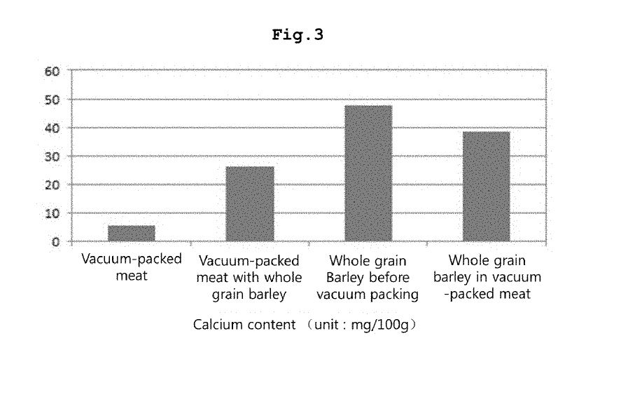

So as to check the changes in micronutrients in accordance with the aging conditions of meat, inorganic matters (calcium, iron, and selenium) and vitamins (vitamins B1, B2 and E, folic acid, and niacin) as the ingredients having representativeness and functionality of the whole grain barley were checked, and the checked results are listed in Table 7. Further, a graph for showing the analysis results of calcium contents is shown in FIG. 3.

TABLE 7

| | | Vacuum- | | |
|---|---|---|---|---|
| | | packed meat | | |
| | | with whole | Whole grain | |
| | Vacuum- | grain | barley | Whole grain |
| | packed meat | barley | before | barley in |
| | (aging for | (aging for | vacuum | vacuum- |
| Item | 14 days) | 14 days) | packing | packed meat |
| Calcium | 5.44 | 26.42 | 47.82 | 38.47 |
| Iron | 1.4 | 2.07 | 3.52 | 3.3 |
| Selenium | 0.711 | 1.038 | 0.016 | 0.035 |
| Vitamin B1 | 0.7 | 0.7 | 0.3 | 0.4 |
| Vitamin B2 | 0.9 | 1.3 | 0.8 | 0.8 |
| Vitamin E | 0.5 | 0.7 | 0.6 | 0.8 |
| Folic acid | 0 | 0 | 0 | 0 |
| Niacin | 4.4 | 3.4 | 0 | 0 |

(Unit: mg/100 g)

The calcium content of the vacuum-packed meat was 5.44 mg/100 g, and contrarily, that of the vacuum-packed meat with whole grain barley was 26.42 mg/100 g, which was more increased by 4.9 times than that of the vacuum-packed meat. This meant the calcium ingredients of the whole grain barley were discharged and transferred to the meat. The cleaned whole grain barley was utilized as the material for vacuum-packing the meat, so that the calcium contained in the hulls of the barley was transferred to the meat, thereby achieving calcium intake when the meat was eaten. Further, the iron content of the vacuum-packed meat was 1.4 mg/100 g, and contrarily, that of the vacuum-packed meat with whole grain barley was 2.07 mg/100 g, which was more increased by about 1.5 times than that of the vacuum-packed meat. Furthermore, the content of the selenium having antioxidant and anticancer activities of the vacuum-packed meat was 0.711 mg/100 g, and contrarily, that of the vacuum-packed meat with whole grain barley was 1.038 mg/100 g, which was more increased by about 1.5 times than that of the vacuum-packed meat.

The vitamin B2 of the vacuum-packed meat with whole grain barley was more increased by 0.4 mg/100 g than that of the vacuum-packed meat, and the vitamin E of the vacuum-packed meat with whole grain barley was more increased by 0.2 mg/100 g than that of the vacuum-packed meat. There was no big change in the contents of vitamin B1 between the vacuum-packed meat with whole grain barley and the vacuum-packed meat. Niacin, which was not detected from the whole grain barley, was more decreased by 1 mg/100 g than that of the vacuum-packed meat, and folic acid was not detected from the meat and the whole grain barley.

### 7. Fatty Acids and Cholesterol

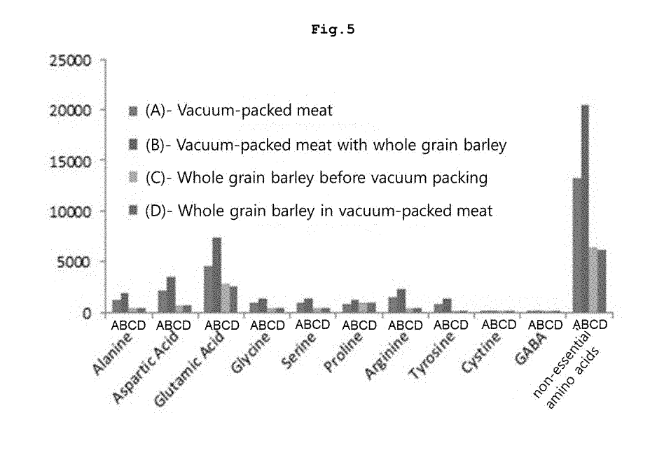

As listed in the general ingredient inspection result (See FIG. 5) according to the aging conditions of meat, the crude fats of the vacuum-packed meat with whole grain barley were more increased by 2.7% than those of the vacuum-packed meat. The changes in the crude fats and the changes in the fatty acid composition were checked, and their relation was also checked. The analysis results of 37 kinds of fatty acids are listed in Tables 8, 9 and 10.

TABLE 8

| | | Vacuum- | | |
|---|---|---|---|---|
| | | packed meat | | |
| | | with whole | Whole grain | |
| | Vacuum- | grain | barley | Whole grain |
| | packed meat | barley | before | barley in |
| | (aging for | (aging for | vacuum | vacuum- |
| Item | 14 days) | 14 days) | packing | packed meat |
| C4:0 | 0.000 | 0.000 | 0.000 | 0.000 |
| C6:0 | 0.000 | 0.001 | 0.000 | 0.000 |
| C8:0 | 0.001 | 0.002 | 0.000 | 0.001 |
| C10:0 | 0.006 | 0.010 | 0.000 | 0.001 |
| C11:0 | 0.000 | 0.000 | 0.000 | 0.000 |
| C12:0 | 0.008 | 0.012 | 0.001 | 0.004 |
| C13:0 | 0.000 | 0.000 | 0.000 | 0.000 |
| C14:0 | 0.084 | 0.177 | 0.011 | 0.010 |
| C14:1 | 0.002 | 0.006 | 0.000 | 0.000 |
| C15:0 | 0.003 | 0.007 | 0.002 | 0.001 |
| C15:1 | 0.000 | 0.000 | 0.000 | 0.000 |
| C16:0 | 1.299 | 2.756 | 0.493 | 0.249 |
| C16:1 | 0.133 | 0.316 | 0.003 | 0.003 |
| C17:0 | 0.016 | 0.034 | 0.002 | 0.001 |
| C17:1 | 0.013 | 0.034 | 0.000 | 0.000 |
| C18:0 | 0.710 | 1.226 | 0.023 | 0.019 |
| C18:1n-9, | 0.020 | 0.050 | 0.000 | 0.000 |
| trans | | | | |
| C18:1n-9, | 2.408 | 5.485 | 0.255 | 0.141 |
| Cis | | | | |
| C18:2n-6, | 0.010 | 0.023 | 0.001 | 0.001 |
| trans | | | | |
| C18:2n-6, | 0.766 | 2.143 | 1.061 | 0.465 |
| trans | | | | |

(Unit: g/100 g)

TABLE 9

| | | Vacuum- | | |
|---|---|---|---|---|
| | | packed | | |
| | | meat with | Whole | Whole |
| | Vacuum- | whole | grain | grain |
| | packed | grain | barley | barley in |
| | meat | barley | before | vacuum- |
| | (aging for | (aging for | vacuum | packed |
| Item | 14 days) | 14 days) | packing | meat |
| C20:0 | 009 | 028 | 003 | 002 |
| C18:3n-6 | 0.005 | 0.006 | 0.000 | 0.001 |
| C20:1 | 0.039 | 0.088 | 0.013 | 0.006 |
| C18:3n-3 | 0.037 | 0.065 | 0.097 | 0.040 |
| C21:0 | 0.000 | 0.000 | 0.000 | 0.000 |
| C20:2 | 0.029 | 0.050 | 0.002 | 0.001 |
| C22:0 | 0.000 | 0.005 | 0.004 | 0.000 |
| C20:3n-6 | 0.013 | 0.022 | 0.000 | 0.000 |
| C22:1n-9 | 0.003 | 0.006 | 0.004 | 0.003 |
| C20:3n-3 | 0.005 | 0.008 | 0.000 | 0.000 |
| C20:4n-6 | 0.000 | 0.000 | 0.001 | 0.000 |
| C23:0 | 0.078 | 0.145 | 0.000 | 0.000 |
| C22:2 | 0.000 | 0.000 | 0.000 | 0.000 |
| C24:0 | 0.000 | 0.000 | 0.003 | 0.000 |
| C20:5n-3 | 0.000 | 0.000 | 0.000 | 0.000 |
| C24:1 | 0.000 | 0.000 | 0.002 | 0.001 |
| C22:6n-3 | 0.006 | 0.007 | 0.000 | 0.000 |

(Unit: g/100 g)

TABLE 10

| | | Vacuum- | | |
|---|---|---|---|---|
| | | packed | | |
| | | meat with | Whole | Whole |
| | Vacuum- | whole | grain | grain |
| | packed | grain | barley | barley in |
| | meat | barley | before | vacuum- |
| | (aging for | (aging for | vacuum | packed |
| Item | 14 days) | 14 days) | packing | meat |
| Total fatty | 5.703 | 12.712 | 1.981 | 0.950 |
| acid | | | | |
| Saturated fatty | 2.214 | 4.403 | 0.542 | 0.288 |
| acid | | | | |
| Trans fatty | 0.030 | 0.073 | 0.001 | 0.001 |
| acid | | | | |
| Unsaturated | 3.459 | 8.236 | 1.438 | 0.661 |
| fatty acid | | | | |
| Monounsaturated | 2.598 | 5.935 | 0.275 | 0.153 |
| fatty acid | | | | |
| Polyunsaturated | 0.861 | 2.301 | 1.163 | 0.508 |
| fatty acid | | | | |
| Cholesterol | 45 | 64 | 0 | 0 |
| (mg/100 g) | | | | |

(Unit: g/100 g)

As appreciated from Table 10, the total fatty acids of the vacuum-packed meat were 5.7 g/100 g, and contrarily, those of the vacuum-packed meat with whole grain barley were 12.7 g/100 g, which was more increased by about 2.2 times than those of the vacuum-packed meat. Of course, the saturated fatty acids of the vacuum-packed meat with whole grain barley were more increased than those of the vacuum-packed meat. On the other hand, the unsaturated fatty acids of the vacuum-packed meat were 3.5% (3.46 g/100 g), and contrarily, those of the vacuum-packed meat with whole grain barley were 8.2% (8.237 g/100 g). Particularly, the polyunsaturated fatty acids of the vacuum-packed meat were 0.9% (0.862 g/100 g), and contrarily, those of the vacuum-packed meat with whole grain barley were 2.3% (2.303 g/100 g).

The drastic increment of the unsaturated fatty acids meant that oil as liquid at a normal temperature was increased, so that when the meat was roasted as well as when the meat was cool, a relatively small amount of solid oil was generated. It is generally known that since duck has the smallest content of unsaturated fatty acids in the fatty acid composition thereof, many people like to eat duck. According to the present invention, the content of the unsaturated fatty acids of the whole grain barley was reduced, and the content of the unsaturated fatty acids of the vacuum-packed meat with whole grain barley was increased, which expects that the vacuum-packed meat with whole grain barley according to the present invention will be popular to the modern people who like to eat healthy food.

### 8. Contents of Free Amino Acids

As listed in the general ingredient inspection result (See FIG. 5) according to the aging conditions of meat, the crude proteins of the vacuum-packed meat were 22 g/100 g, and contrarily, those of the vacuum-packed meat with whole grain barley were 35 g/100 g, which was more increased by about 1.6 times than those of the vacuum-packed meat. The changes in the crude proteins and the changes in the amino acid composition were checked, and their relation was also checked.

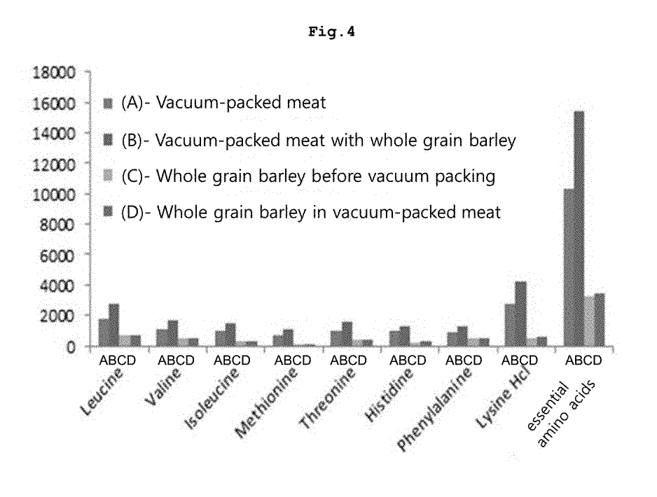

The amino acids are chemical compounds for constituting proteins, and they make the flavor of meat better and the surface of meat changed to brown color looking good. The analysis results of the contents of essential amino acids of the vacuum-packed meat according to the aging methods are listed in Tables 11 and FIG. 4, and the analysis results of the contents of non-essential amino acids of the vacuum-packed meat according to the aging methods are listed in Tables 12 and FIG. 5.

TABLE 11

| | | Vacuum- | Difference | Whole | | |
|---|---|---|---|---|---|---|
| | | packed | value | grain barley | Whole grain | Difference |
| | Vacuum- | meat with | (Δvalue) | before | barley in | value (Δvalue) |
| | packed | whole grain | between two aging | vacuum | vacuum- | between two aging |
| | meat (aging | barley (aging | methods | packing | packed meat | methods |
| Item | for 14 days) (A) | for 14 days) (B) | (B − A) | (C) | (D) | (D − C) |
| Leucine | 1745.23 | 2757.30 | 1012.07 | 698.50 | 720.75 | 22.25 |
| Valine | 1102.14 | 1711.41 | 609.27 | 500.05 | 510.57 | 10.52 |
| Isoleucine | 1016.79 | 1504.22 | 487.43 | 337.50 | 335.41 | −2.09 |
| Methionine | 695.03 | 1032.12 | 337.09 | 133.56 | 140.92 | 7.36 |
| Theronine | 1008.96 | 1607.93 | 598.97 | 367.01 | 366.01 | −1.00 |
| Histidine | 1016.40 | 1275.83 | 259.43 | 214.18 | 281.33 | 67.15 |
| Phenylalanine | 921.25 | 1290.64 | 369.39 | 478.00 | 468.17 | −9.83 |
| Lysine | 2781.62 | 4208.42 | 1426.80 | 537.61 | 578.60 | 40.99 |
| Totals of | 10287.42 | 15387.87 | 5100.45 | 3266.41 | 3401.76 | 135.35 |
| essential | | | | | | |
| amino acids | | | | | | |

(Unit: mg/100 g)

The essential amino acids are not produced in the human body, and accordingly, they should be necessarily taken by food. Leucine among 8 kinds of dietary essential amino acids is the only amino acid that stimulates protein synthesis, increases muscle protein synthesis, and decreases muscle protein degradation, thereby helping muscle mass increased. Accordingly, bodybuilders eat a lot of leucine as a supplement, while taking their muscle exercise. The leucine of the vacuum-packed meat was 1745.23 mg/100 g, and contrarily, that of the vacuum-packed meat with whole grain barley was 2757.3 mg/100 g, which was more increased by 1012.07 mg/100 g (158.0%) than that of the vacuum-packed meat.

The valine of the vacuum-packed meat was 1102.14 mg/100 g, and contrarily, that of the vacuum-packed meat with whole grain barley was 1711.41 mg/100 g, which was more increased by 609.27 mg/100 g (55.3%) than that of the vacuum-packed meat.

The isoleucine of the vacuum-packed meat was 1016.79 mg/100 g, and contrarily, that of the vacuum-packed meat with whole grain barley was 1504.22 mg/100 g, which was more increased by 487.43 mg/100 g (147.9%) than that of the vacuum-packed meat.

Also, the methionine, threonine, histidine, and phenylalanine of the vacuum-packed meat with whole grain barley were more increased than those of the vacuum-packed meat and the lysine of the vacuum-packed meat with whole grain barley was more increased by 1426.80 mg/100 g than that of the vacuum-packed meat.

The total of essential amino acids of the vacuum-packed meat was 10287.42 mg/100 g, and contrarily, that of the vacuum-packed meat with whole grain barley was 15387.87 mg/100 g, which was more increased by 5100.45 mg/100 g (149.6%) than that of the vacuum-packed meat.

TABLE 12

| | | | Difference | Whole | | Difference |
|---|---|---|---|---|---|---|
| | | Vacuum-packed | value | grain | | value |
| | | meat with | (Δvalue) | barley | Whole grain | (Δvalue) |
| | Vacuum-packed | whole grain | between | before | barley in | between |
| | meat (aging | barley (aging | two aging | vacuum | vacuum-packed | two aging |
| | for 14 days) | for 14 days) | methods | packing | meat | methods |
| Item | (A) | (B) | (B − A) | (C) | (D) | (D − C) |
| Alanine | 1271.90 | 1940.08 | 668.18 | 450.79 | 448.09 | −2.70 |
| Aspartic Acid | 2242.28 | 3490.33 | 1248.05 | 665.55 | 681.96 | 16.41 |
| Glutamic Acid | 4623.61 | 7422.26 | 2798.65 | 2799.07 | 2542.08 | −256.99 |
| Glycine | 960.24 | 1372.18 | 411.94 | 419.11 | 407.29 | −11.82 |
| Serine | 906.27 | 1390.66 | 484.39 | 443.88 | 421.21 | −22.67 |
| Proline | 877.23 | 1248.02 | 370.79 | 949.96 | 938.76 | −11.20 |
| Arginine | 1475.62 | 2279.78 | 804.16 | 463.97 | 491.42 | 27.45 |
| Tyrosine | 848.50 | 1320.26 | 471.76 | 148.61 | 193.70 | 45.09 |
| Cystine | 68.89 | 54.71 | −14.18 | 50.47 | 50.72 | 0.25 |
| GABA | 29.50 | 2.20 | −27.30 | 14.34 | 25.09 | 10.75 |
| Totals of | 13304.04 | 20502.48 | 7216.44 | 6405.75 | 6200.32 | −205.43 |
| non-essential | | | | | | |
| amino acids | | | | | | |

(Unit: mg/100 g)

The alanine of non-essential amino acids of the vacuum-packed meat was 1271.9 mg/100 g, and contrarily, that of the vacuum-packed meat with whole grain barley was 1940.08 mg/100 g, which was more increased by 668.18 mg/100 g (152.5%) than that of the vacuum-packed meat.

Particularly, glutamic acid representatively provides good taste of food. The glutamic acid of the vacuum-packed meat was 4623.61 mg/100 g, and contrarily, that of the vacuum-packed meat with whole grain barley was 7422.26 mg/100 g, which was more increased by 2798.65 mg/100 g (160.5%) than that of the vacuum-packed meat.

In addition, the aspartic acid, glycine, serine, proline, argine, and tyrosine of the vacuum-packed meat with whole grain barley were more increased by 140 to 160% than those of the vacuum-packed meat.

The total of non-essential amino acids of the vacuum-packed meat was 13304.04 mg/100 g, and contrarily, that of the vacuum-packed meat with whole grain barley was 20502.48 mg/100 g, which was more increased by 6946.44 mg/100 g (152.2%) than that of the vacuum-packed meat.

According to the taste classification of amino acids of meat, further, glycine, alanine, threonine, proline and serine had sweet tastes, and glutamic acid had a savory taste. All of items of the detected amino acids of the vacuum-packed meat with whole grain barley were much more increased than those of the vacuum-packed meat, which had a relation with the sensory evaluation wherein the vacuum-packed meat with whole grain barley had a better taste than the vacuum-packed meat.

The aspartic acid is an essential ingredient of flavoring substances, and if any amino acid is solely heated, a specific meat flavor is not generated. However, when various kinds of amino acids and sugar are mixed with each other, the specific meat flavor is produced. The taste of meat is much dependent upon glutamic acid and inosinic acid, and the preference of meat is dependent upon other amino acids and peptides. There is a possibility that the balance between the quantities of peptides and amino acids produced in the protein decomposition process makes the meat taste good.

In case of the amino acids of the whole grain barley, the amino acids of the whole grain barley in the vacuum-packed meat were a little more decreased and increased than those before vacuum-packed meat. In case of the whole grain barley in the vacuum-packed meat, however, the total of essential amino acids was 135.35 mg/100 g, and the total of non-essential amino acids was −205.43 mg/100 g, which had a very smaller change than that of the amino acids of the meat.

This meant that the amino acids of the whole grain barley were not transferred to the meat but rather the taste ingredients of the amino acids were actively produced through the chemical variations caused by the protein decomposition generated during the aging process of the meat.

### 9. Peroxide Value and Acidity

The ingredient analysis test was carried out for acid values and peroxide values in accordance with the aging conditions of meat. Even in case of the aging in the vacuum packing state, it was hard to conduct complete degassing, and the meat came into contact with the remaining oxygen during the aging, thereby causing the oxidization of a lipid portion thereof and increasing the content of the peroxide value. Accordingly, the changes in the contents of antioxidant vitamins, antioxidant minerals, and fat oxides (acid values and peroxide values) were measured, and the measured results are listed in Table 13.

An acid value is the number of milligrams of potassium hydroxide (KOH) required to neutralize the free fatty acid in one gram of fat and oil. That is, the acid value is obtained by measuring the amount of the free fatty acid in which the fatty acid is not bonded by glyceride. The acid value is a variable changed by the preservation and heating of fat and oil, which is a constant required for determining the quality of food containing the fat and oil, and if the acid value of food is more than 30, the food is not edible.

Further, the peroxide value is the equivalent number of milligrams of peroxide contained in one kilogram of fat and oil. As the oxidization of the fat and oil is developed, the peroxide is increased and then decomposed into carbonyl compounds, and finally, the peroxide is decreased. The peroxide value is a scale indicating the degree of rancidity in an initial step of the fat and oil. Accordingly, the higher the peroxide value of food is, the higher the degree of rancidity of the fat and oil is, so that the food is not edible. Generally, if vegetable fat and oil has the peroxide value in the range of 60 to 100 meq/kg, and if animal fat and oil has the peroxide value in the range of 20 to 40 meq/kg, their rancidity starts.

TABLE 13

| | | | Difference |
|---|---|---|---|
| | | Vacuum-packed | value |
| | Vacuum-packed | meat with whole | (Δvalue) |
| | meat | grain barley | between two |
| | (aging for 14 | (aging for 14 | aging methods |
| Item | days) (A) | days) (B) | (B − A) |
| pH | 5.3 | 5.1 | −0.2 |
| Acid value | 2.9 | 3.6 | 0.7 |
| Peroxide | 10.7 | 1.0 | −9.7 |
| value | | | |
| (meq/kg) | | | |
| Vitamin E | 0.5 | 0.7 | 0.2 |
| (mg/100 g) | | | |
| Selenium | 0.711 | 1.038 | 0.327 |
| (mg/100 g) | | | |

As appreciated from the test for the acid value and the peroxide value according to the aging conditions of meat, the peroxide value, as an initial rancidity index of fat, of the vacuum-packed meat was 10.7 meq/kg, and contrarily, that of the vacuum-packed meat with whole grain barley was 1 meq/kg, which was more decreased by 9.7 meq/kg (90.7%) than that of the vacuum-packed meat. Further, the antioxidant vitamin E of the vacuum-packed meat with whole grain barley was 0.7 mg/100 g, which was more increased by 140% than that of the vacuum-packed meat. Also, the selenium, as antioxidant mineral, of the vacuum-packed meat was 0.711 mg/100 g, and contrarily, that of the vacuum-packed meat with whole grain barley was 1.038 mg/100 g, which was more increased by 146.0% than that of the vacuum-packed meat. Accordingly, the automatic oxidization of the fat and oil was prevented to suppress the production of the peroxides.

The acid value had a relation with the free fatty acid, and accordingly, the fatty acid of the vacuum-packed meat with whole grain barley was a little higher two times than the vacuum-packed meat. The acid value was measured from the free fatty acid as well as various acids like amino acids, which was appreciated from the result wherein the vacuum-packed meat with whole grain barley had a lower pH value by 0.2 than the vacuum-packed meat. Accordingly, the rancidity of the fat and oil of the vacuum-packed meat with whole grain barley was not more developed than that of the vacuum-packed meat, but if the acid value of food was more than 30, the food was not edible. However, the acid values of the vacuum-packed meat and the vacuum-packed meat with whole grain barley were 2.9 and 3.6, which were good values.

As appreciated from the values of Table 13, the contents of the antioxidant vitamin and antioxidant mineral of the vacuum-packed meat with whole grain barley were high, so that the peroxide value thereof was decreased. It was understood that the vacuum-packed meat with whole grain barley had high storage ability and maintained the freshness thereof well.

Unlike the meat (that is, the vacuum-packed meat) aged through general wet aging, in conclusion, the meat (that is, the vacuum-packed meat with whole grain barley) aged using the whole grain barley through the wet aging allows the water of the whole grain barley to be contained therein, so that the food texture and flavor thereof are excellent, the loss of meat juice is prevented, the contents of antioxidant vitamins are increased to avoid the rancidity of the fat thereof, the acid value and the peroxide value thereof are lowered, and the contents of essential amino acids and non-essential amino acids are increased, thereby improving both of the taste and the nutrition thereof to provide high functionality thereof.

As described above, the method for aging meat using whole grain barley according to the present invention provides a simpler aging process than the conventional meat aging method using the manufactured food additive or using a variety of extracted liquids or fermented liquids, thereby preventing the inherent taste and properties of the meat from being changed unpleasantly by means of the added food additive or extracted or fermented liquids.

Additionally, the method for aging meat using whole grain barley according to the present invention prevents the loss of the juice contained in the meat aged using the whole grain barley to the maximum by means of the whole grain barley attached to the surface of the meat, and on the contrary, the water contained in the whole grain barley is absorbed to the meat to allow the juice and taste of the meat to become rich. That is, the hulls of the whole grain barley are aged together with the meat to allow the water of the meat to be adjusted to the optimal state, so that the quality of the protein portion of the meat becomes softened and the quality of the fat portion of the meat becomes harder, thereby allowing the taste and food texture of the meat to be excellent.

Moreover, the method for aging meat using whole grain barley according to the present invention allows the lean flavor and savory taste of the whole grain barley to be permeated into the meat, thereby removing the unpleasant smell of the meat to enhance the flavor and taste of the meat, and further allows the oil of the meat to be maintained to an optimal state, thereby providing excellent savory taste of meat. Further, the delicate smell of the barley is added to the meat, thereby providing a good appetite.

Furthermore, the method for aging meat using whole grain barley according to the present invention fills the interior of the vacuum packing material sequentially with the first layer of whole grain barley, the layer of meat, and the second layer of whole grain barley in such a manner as to allow the whole grain barley to completely surround the meat therewith, and then conducts the aging of the meat packed together with the whole grain barley through the wet aging in the low temperature aging refrigerator. Accordingly, the meat is distributed in the state of being packed, and thus, the smell of the whole grain barley is much contained in the meat, thereby more increasing the quality and flavor of the meat.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method for aging meat using whole grain barley, the method comprising:
the preparation step of preparing a vacuum packing material, whole grain barley, and meat having a thickness in the range of 0.5 to 12 cm and applied uniformly with barley grass powder to the surface thereof;
the meat and whole grain barley filling step of filling the interior of the vacuum packing material with a first layer of whole grain barley formed to a volume in the range of 20 to 200% with respect to the volume of meat, a layer of meat formed by arranging pieces of meat serially on the first layer of whole grain barley, and a second layer of whole grain barley formed on top of the layer of meat to a volume in the range of 20 to 200% with respect to the volume of meat;
the vacuum packing step of conducting the vacuum packing for the meat and the whole grain barley filled in the vacuum packing material; and
the wet aging step of conducting wet aging in which the vacuum-packed meat with the whole grain barley is aged for 7 to 40 days in a low temperature aging refrigerator kept at a temperature in the range of 0 to 4° C.

2. The method according to claim 1, wherein the meat in the preparation step comprises any one selected from the group consisting of beef, pork, chicken, and duck.

3. The method according to claim 1, wherein the whole grain barley in the preparation step is germinated whole grain barley.

4. The method according to claim 1, wherein in the meat and whole grain barley filling step, pieces of charcoal are additionally laid on the first layer of whole grain barley, and the pieces of charcoal contain 2 to 5 parts by weight with respect to 100 parts by weight of the whole grain barley.

5. Aged meat prepared by the method according to claim 1.

6. Aged meat prepared by the method according to claim 2.

7. Aged meat prepared by the method according to claim 3.

8. Aged meat prepared by the method according to claim 4.
